(19) United States
(12) Patent Application Publication
(10) Pub. No.: US 2002/0039651 A1
(43) Pub. Date: Apr. 4, 2002

(54) Adhesive film for displays

(76) Inventor: Chikara Murata, Shizuoka (JP)

Correspondence Address: ARENT FOX KINTNER PLOTKIN & KAHN, 1050 CONNECTICUT AVENUE, N.W., SUITE 600, WASHINGTON, DC, 20036, US

(21) Appl. No.: 09/866,923

(22) Filed: May 30, 2001

(30) Foreign Application Priority Data
May 31, 2000 (JP) 2000-162346

(51) Int. Cl. B32B 7/12; B32B 15/04

(52) U.S. Cl. 428/354; 428/343

(57) ABSTRACT

The present invention provides an adhesive film for a display which exhibits superior anti-reflective properties, anti-static properties and/or infrared ray blocking properties, and in addition, superior image contrast and color reproduction. In an adhesive film for a display comprising at least three layers of a transparent substrate, an optical functional layer, and an adhesive layer, at least two layers of these layers are colored, and these colors are made to be achromatic by mixing.

### BACKGROUND OF THE INVENTION

The present invention relates to an adhesive film which is suitable for use in displays such as liquid crystal displays (LCDs), plasma displays (PDPs), CRTs, ELs, etc., and in particular, relates to an adhesive film exhibiting superior image contrast and color reproduction.

Displays typified by LCDs, PDPs, CRTs, and ELs are widely used in various fields such as television and computer technologies, and these have been developed rapidly. In particular, LCDs are in remarkably common use in lap-top-type personal computers and word processors, portable telephones, PHSs, various portable terminals, etc., as displays which are thin, light, and extremely versatile.

A screen of a conventional display such as a television CRT, etc., comprises a glass body containing a colorant such as carbon black, etc. The glass body containing the colorant can preferably display from white, which is a mixture of the three colors red, green, and blue, to black, which is a non-colored part, and can exhibit superior image contrast by adjusting the transmitted amount of light from a light source and is usually colored gray.

In addition, recently, a flat display in which the light source side, such as a CRT, etc., is a curved surface, and the viewer side, that is, the outside thereof, is a flat surface, has been widely used. The thickness of the glass body in this flat display is thinnest at the center of the screen and increases with distance from the center toward the edge thereof. In such a glass body in which the thickness differs depending on the distance from the center, in order to ensure uniform light transmittance or diffusivity over the entire screen, it is necessary that the coloring be deep at the center and gradually lighten from the center toward the edge, so as to be in inverse proportion to the thickness of the glass body.

However, the glass body in which coloring concentration gradually changes as the above complicates the production process, thereby increasing production costs. In addition, it is not suitable in practice since it is necessary that the degree of the coloring change appropriately depending on the type of the light source or type of the display material.

Furthermore, in the various displays described in the above, a laminated composition is generally provided to yield various properties such as an anti-reflection property, anti-glare property, anti-static property, infrared ray blocking property, etc. However, in displays provided with such a layered composition, there was a problem in that the layered compositions were colored due to materials added to obtain the above anti-reflection property, anti-static property, and infrared ray blocking property, and therefore color reproduction of images was degraded.

### SUMMARY OF INVENTION

Therefore, the present invention has been made in view of the above circumstances, and it is an object thereof to provide an adhesive film for a display which exhibits superior anti-reflective properties, anti-static properties and/or infrared ray blocking properties, and which exhibits superior image contrast and color reproduction.

The inventors have conducted various research with respect to coloring of films due to addition materials for obtaining the above properties, and consequently, they have found that the overall color of a film can be made to be achromatic, for example, black or neutral gray, by providing a colored layer having a relationship of being a complementary color to the color of another colored layer containing the material (the color mixed with each color of the colored layers when two layers or more, for example, an anti-reflective layer and an infrared ray blocking layer, are laminated, respectively), and superior image contrast and color reproduction can be exhibited in the case in which an adhesive layer is used in a display.

Therefore, an adhesive film for a display according to the present invention comprises at least three layers which are a transparent substrate, an optical functional layer, and an adhesive layer, and is characterized in that at least two layers in the adhesive film are colored, and these colors are made to be achromatic by mixing.

In addition, a preferable aspect of an adhesive film of the present invention is characterized in that an optical functional layer is provided on one surface of a transparent substrate, and an adhesive layer is provided on another surface of the transparent substrate, and the optical functional layer has at least one of an anti-reflective property, an anti-static property, and an infrared ray blocking property.

Furthermore, another preferable aspect of an adhesive film of present invention is characterized in that an optical functional layer and an adhesive layer are provided on one surface of a transparent substrate, in this order, and the optical functional layer has an infrared ray blocking property. It is preferable that an optical functional layer in the above laminated composition contain a hard coat material as a binding agent.

Next, further preferable embodiments of the present invention will be explained in detail.

In an adhesive film for a display of the present invention, at least one layer colored due to materials added to obtain properties such as an anti-reflection property, anti-static property, infrared ray blocking property, etc., for example, resin, pigment, dye, etc., is provided, and at least one layer colored so as to have a relationship of being a complementary color to the color of the colored layer or the color mixed each color of the colored layers, is further provided. That is, at least two layers in a laminated composition of an adhesive film for a display of the present invention are colored, and these colors are made to be achromatic by mixing. These colored layers may be any layers in the laminated composition.

“Achromatic” in the present invention refers to a hue in which a value a and a value b are nearly zero in Lab hue expressions. Specifically, an achromatic hue is preferably a hue in which a value a and a value b are within ±5, respectively, more preferably a hue in which a value a is within ×3 and a value b is within ±4, and most preferably a hue in which a value a is +1 to -2.5 and a value b is within ±3.5. When one of a value a and a value b is outside the above range, the color of display is affected, and therefore image contrast and color reproduction are deteriorated.

In an adhesive film for a display of the present invention, pigment or dye is mixed in a transparent substrate, adhesive layer, or another layer provided, depending on the situation, such as a hard coat layer, anti-glare layer, etc., except for an optical functional layer, in order to specify a value a and a value b in Lab hue expressions, and the overall color of an adhesive film for display as a final product is thereby made to be achromatic.

As a pigment, iso-indolinone pigment, anthraquinone pigment, dioxazine pigment, azo pigment, naphthol pigment, quinophthalone pigment, azomethine pigment, benzimidazolone pigment, perynone pigment, pyranthlone pigment, quinacridone pigment, perylene pigment, phthalocyanine pigment, then pigment and the like can be mentioned. Among these, red pigments such as dioxazine pigment, azo pigment, naphthol pigment, quinacridone pigment, and blue pigments such as phthalocyanine pigment are preferable, and as a most suitable pigment, quinacridone pigment, dioxazine pigment, and copper phthalocyanine pigment can be employed. Furthermore, the average particle size of these pigments is preferably 0.01 to 5 μm, and more preferably 0.01 to 1 μm.

Although various dyes can be used appropriately as the dye, in the present invention, a pigment is further preferably employed since dyes are inferior in weather resistance, and changes in light transmittance in use over long periods are large.

In the following, laminated compositions and materials which constitute an adhesive film for a display of the present invention will be explained in detail.

A. Transparent Substrate

As a transparent substrate employed in an adhesive film according to the present invention, a conventional transparent film, glass, etc., can be employed. Specifically, various resin films such as polyethylene terephthalate (PET), triacetyl cellulose (TAC), polyacrylate, polyimide, polyether, polycarbonate, polysulfone, polyether sulfone, cellophane, aromatic polyamide, polyethylene, polypropylene, polyvinyl alcohol, and the like, and glass based materials such as fused glass, soda glass, and the like can be preferably employed. For PDPs and LCDs, PET and TAC are preferred.

The higher the transparency of the transparent substrate, the more desirable the transparent substrate. The light transmittance (Japanese Industrial Standard C-6714) is preferably 80% or more, and is more preferably 90% or more. In the case in which the transparent substrate is employed in a compact and light-weight liquid-crystal display, the transparent substrate is preferably in the form of a film. It is desirable that the transparent substrate be thin from the standpoint of being light-weight, and it is preferred that the thickness of the transparent substrate be preferably 10 to 700 μm in consideration of the productivity thereof.

In addition, the adhesion between the optical functional layer and the transparent substrate can be improved by surface-treatment of the transparent substrate such as an alkaline treatment, corona treatment, plasma treatment, fluorine treatment, sputtering treatment, or the like, a coating, on the transparent substrate, of a surface active agent, a silane coupling agent, or the like, or a surface-modification-treatment such as an Si deposition or the like.

B. Optical Functional Layer

A “optical functional layer” in the present invention refers to a layer having at least one function of anti-reflection property, anti-static property, infrared ray blocking property, etc. That is, the optical functional layer may also be a layer having at least one of the above functions, or a layer in which two or more layers having each function such as an anti-reflection layer, an anti-static layer, and an infrared ray blocking layer, are laminated. In this case, it is preferable that the anti-reflection layer or the anti-static layer be provided on a surface, which is not provided with an adhesive layer, of a transparent substrate, since superior properties can be obtained. The infrared ray blocking layer may be provided on the surface of a transparent substrate or between a transparent substrate and an adhesive layer.

In the following, each optical function layer will be specifically explained.

\mathring{1} Anti-reflection Layer

In an anti-reflection layer, an anti-reflection effect is obtained by providing one low refractive index layer consisting of material having a lower refractive index than that of a transparent substrate on the transparent substrate, or by providing at least one pair of a two-layer structure in which a low refractive index layer having a lower refractive index than that of a high refractive index layer is provided on the high refractive index layer, on the transparent substrate. In the present invention, “high refractive index and low refractive index” refer to relative relationships between refractive indexes of joined layers.

In the high refractive index layer, for example, resin used as a binding agent, such as an acrylic resin, vinyl chloride resin, vinyl acetate resin, styrene resin, epoxy resin, polyester resin, urethane resin, or the like and preferably for forming a hard coat layer described in the following, can be usually employed alone or by adding high refractive index materials therein. As a high refractive index material, a resin including an aromatic ring or a halogen element such as Br, I, Cl, etc., such as a styrol plastic such polystyrene, etc., PET, polycarbonate of bisphenol A, polyvinyl chloride, such as polytetrabromobisphenol A glycidyl ether, etc., and a resin including S, N, P, etc., such as polyvinyl pyridine, polybisphenol S glycidyl ether, or the like can be recited. Additionally, as another high refractive index material, an inorganic compound fine particle of TiO₂ (refractive index: n=2.3 to 2.7), CeO₂ (n=1.95), ZnO (n=1.9), Sb₂O₅ (n=1.71), SnO₂ (n=1.95), ITO (n=1.95), Y₂O₃ (n=1.87), La₂O₃ (n=1.95), ZrO₂ (n=2.05), Al₂O₃ (n=1.63), HfO₂ (n=2.00), Ta₂O₅, or the like can be recited. These may be employed alone or in combination.

In addition, a low refractive index layer comprises, for example, an inorganic low refractive index material wherein an inorganic material such as SiO₂ (refractive index: n=1.35 to 1.45), LiF (n=1.4), MgF₂ (n=1.4), 3NaF.AlF₃ (n=1.4), AlF₃ (n=1.4), Na₃AlF₆ (n=1.33), or the like is microgranulated, and the microgranules are contained in an acrylic resin or an epoxy resin, or an organic low refractive index material such as a fluorine-containing compound, a silicone type organic compound, a thermoplastic resin, a thermosetting resin, a radiation curable resin, or the like. It is preferable that the refractive index of the low refractive index layer be 1.45 or less. Among these in the present invention, a fluorine-containing compound is particularly preferred in view of stain-preventing effects. Furthermore, it is preferable that the critical surface tension of the low refractive index layer be 20 dyne/cm or less. In the case where the critical surface tension is more than 20 dyne/cm, it is difficult for stains adhered on the surface layer to be wiped off.

As the fluorine-containing compound described above, there can be mentioned a fluorinated vinylidene type copolymer which can be dissolved in an organic solvent and is easy to apply, a fluoro-olefin/hydrocarbon copolymer, a fluorine-containing epoxy resin, a fluorine-containing epoxy acrylate, a fluorine-containing silicone, a fluorine-containing alkoxysilane, as well as TEFLON AF 1600 (produced by Dupont Inc., n=1.30), CYTOP (produced by Asahi Glass Corporation, n=1.34), 17 FM (produced by Mitsubishi Rayon Corporation, refractive index n=1.35), Opster JN-7212 (produced by Nihon Gosei Gum Corporation, n=1.40), LR 201 (produced by Nissan Chemical Industry Corporation, n=1.38), or the like. These may be employed alone or in combination.

In addition, as another fluorine-containing compound, a radiation-curable-type fluorine-containing monomer, oligomer, prepolymer, or the like such as a fluorine-containing methacrylate such as 2-(perfluorodecyl)ethyl methacrylate, 2-(perfluoro-7-methyloctyl)ethyl methacrylate, 3-(perfluoro-7-methyloctyl)-2-hydroxypropyl methacrylate, 2-(perfluoro-9-methyldecyl)ethyl methacrylate, 3-(perfluoro-8-methyldecyl)-2-hydroxypropyl methacrylate, or the like, a fluorine-containing acrylate such as 3-perfluorooctyl-2-hydroxypropyl acrylate, 2-(perfluorodecyl)ethyl acrylate, 2-(perfluoro-9-methyldecyl)ethyl acrylate, or the like, an epoxide such as 3-perfluorodecyl-1,2-epoxy propane, 3-(perfluoro-9-methyldecyl)-1,2-epoxy propane, or the like, an epoxy acrylate, or the like can be employed. These can be employed alone or in combination.

In addition, a low refractive index material obtained by mixing a fluorine-type film-forming agent and a sol wherein silica microparticles having a particle size of 5 to 30 nm are dispersed in water or an organic solvent can be employed. As the sol wherein silica microparticles having a particle size of 5 to 30 nm are dispersed in water or an organic solvent, a well-known silica sol obtained by means of condensation of an activated silicic acid such as a method for de-alkalization using an ion exchange of an alkali metal ion in an alkaline salt of silicic acid, or a method for neutralization of an alkaline salt of silicic acid with a mineral acid; a well-known silica sol obtained by means of hydrolysis and condensation of an alkoxysilane in an organic solvent in the presence of a basic catalyst; or an organic-solvent type silica sol (organosilica sol) obtained by replacing the water in an aqueous silica sol described above with an organic solvent by a distillation method may be employed. These silica sols can be employed in either an aqueous or organic-solvent condition. The organic-solvent type silica sol contains a solid component as SiO₂ in a concentration of 0.5 to 50% by weight. Various types of silica ultra-microparticles in the silica sol such as in a spheroidal form, a needle form, a plate form, or the like can be employed.

In addition, as a film forming agent, an alkoxysilane, a metal alkoxide, a hydrolysate of metal salt, fluorine-modified polysiloxane, or the like can be employed. Of the film forming agents described above, in particular, a fluorine compound is preferably employed in order to decrease the critical surface tension of the low refractive index layer and prevent oil from adhering. The low refractive index layer according to the present invention can be obtained, for example, by diluting the materials described above with a solvent, spreading the materials on the high refractive index layer by means of a spin coater, a roll coater, a printer, or the like, drying the materials, and curing them by means of heat or radiation (in the case of UV radiation, a photo-polymerization initiator is necessary). Although the radiation curable-type of fluorine-containing monomer, oligomer, and prepolymer are superior in stain resistance, they may have disadvantages in that the low refractive index layer may be repelled by the high refractive index layer in the case of some composition ratios, or the low refractive index layer may peel off from the high refractive index layer due to inferior wetting properties. For these reasons, it is preferred that the monomer, oligomer, and prepolymer having polymeric unsaturated bonds such as for an acryloyl group, a methacryloyl group, an acryloyloxy group, methacryloyloxy group, or the like, described for the radiation curable resin employed in the high refractive index layer be mixed in an appropriate ratio and be employed.

In the case where, in the transparent substrate, a plastic film such as one of PET, TAC, or the like, which is liable to be damaged by heat, is employed, a radiation curable resin is preferably selected as a material for the low refractive index layer.

The thickness of the low refractive index layer for exhibiting superior anti-reflection properties can be calculated according to a well-known expression. According to a well-known document (Science Library, Physics 9 “Optics”, pp. 70 to 72), when incident light is transmitted vertically to a low refractive index layer, it is considered that the conditions for which the low refractive index layer does not reflect the light and for which the light is transmitted at 100% will be satisfied in the following relational expression. In the expression, N₀ is the refractive index of the low refractive index layer, N_{S} is the refractive index of the high refractive index layer, h is the thickness of the low refractive index layer, and λ₀ is the wavelength of the light.

N₀=N_{S}^{½} Expression (1)

N₀h=λ₀/4 Expression (2)

According to Expression (1), it can be seen that in order to prevent the light reflection completely (100%), a material wherein the refractive index of the low refractive index layer corresponds to the square root of the refractive index of the lower layer (high refractive index layer) may be selected. In practice, it is difficult to find a material that satisfies the expression exactly, and therefore a material which has properties very near to those of a material that satisfies the expression exactly is used. In expression (2), the optimum thickness as an anti-reflection film of the low refractive index layer can be calculated from the refractive index of the low refractive index layer selected according to expression (1) and the wavelength of the light. For example, in the case where the refractive index of the high refractive index layer and that of the low refractive index layer are 1.50 and 1.38, respectively, and the wavelength of the light is 550 nm, an optical film thickness of the low refractive index layer is calculated as approximately 0.1 μm, and is preferably in a range of 0.1±0.01 μm, according to expression (2).

\mathring{2} Anti-static Layer

An anti-static layer may be provided in order to prevent contaminants such as dust from adhering on a display surface due to static charge. The anti-static layer can be formed by depositing or sputtering an extremely thin layer of a metal oxide such as ITO or a metal such as aluminum or tin; by dispersing whiskers and metal microparticles such as those of aluminum or tin, whiskers and microparticles such as those of antimony-doped metal oxide such as tin oxide, fillerized charge-transfer complexes produced between an electron donor such as an organic cation or a metal ion and 7,7,8,8-tetracyanoxydimethane in a polyester resin, an acrylic resin, an epoxy resin, or the like, and subsequently solvent-coating; by solvent-coating a camphor-sulfonic-acid-doped polypyrrol, polyaniline, etc.; or the like. The light transmittance of the anti-static layer is preferably 80% or more in the case of optical use.

\mathring{3} Infrared Ray Blocking Layer

Since infrared rays discharged from a display may cause misoperation of portable telephones, various remote control devices, or the like, an infrared ray blocking layer is provided in order to absorb or reflect infrared rays, in particular, near infrared rays at wavelengths of 800 to 1000 nm. The infrared ray blocking layer is usually provided by laminating a coating material in which dyes or pigments which are infrared ray blocking agents are mixed or dispersed in resins used as a binding agent, preferably in resins for forming the following hard coat layer. The infrared ray blocking agent is not particularly limited, and as a dye type infrared ray blocking agent, for example, SIR 159 and SIR 128 produced by MITSUI CHEMICALS, INC., EX Color 803K and EX Color 901B produced by Nippon Shokubai Kagaku Kogyo Co., Ltd., etc., can be preferably employed. With regard to a pigment type infrared ray blocking agent, the average particle size thereof is preferably 100 nm or less, is more preferably 50 nm or less, and is most preferably 25 to 35 nm, from the viewpoint of transparency and uniformity. Specifically, ITO powder is preferred.

ITO powders can be obtained by well-known methods. For example, an aqueous solution including indium and a small amount of water soluble salt of tin is reacted under alkali conditions, whereby a hydroxide of indium and tin is coprecipitated. Then, the coprecipitated compound is obtained as a raw material, the raw material is sintered in a reducing atmosphere of CO, NH₃, H₂, or the like, and is transformed into an oxide, whereby an ITO powder is obtained. The ITO powder may be obtained by sintering the raw material in a reducing atmosphere. The mole ratio of In/Sn/O₂ is 100/5˜10/0.5˜10, and is preferably 100/5˜10/0.5˜2. In a film produced using ITO powder subjected to reduction treatment, the chromaticity coordinate measured in accordance with Japanese Industrial Standard K-8701 using a spectrophotometer (trade name: UV 3100, produced by Shimadzu Corporation) is x=0.31±0.1, y=0.32±0.1, and z=0.37±0.1, and the film is blue. Such ITO powders are extremely superior in infrared ray blocking so that the shortest wavelength blocked is 800 nm. The color of the infrared blocking layer of the present invention in which such ITO powder is dispersed reflects the color of the ITO powder, that is, the chromaticity coordinate is in the above ranges and the appearance is clear blue.

With regard to the compounding ratio of the powder of the infrared ray blocking agent and the resin in the coating materials for the infrared ray blocking layer, in the case in which the compounding ratio of the powder and the resin is 90/10 to 60/40 by weight, preferably 85/15 to 65/35, and more preferably 80/20 to 70/30, infrared ray blocking films can be obtained which have superior infrared ray blocking properties, high transparency, and low haze, even if the thickness of the layer is about 1 μm. In the case in which the compounding ratio of the powder exceeds 90.0% by weight, the film is colored by the powder and the haze degree therein increases, thereby increasing metallic luster and causing peeling or adhesive failure of the infrared ray blocking layer, so that adhesion to a base film becomes inferior. In the case in which the compounding ratio of the powder is below 60.0% by weight, the object, i.e., infrared ray blocking ability, is not obtained.

\mathring{4} Coating Method

In the present invention, as a method for forming an optical functional layer, directly or via another layer, on one surface of the transparent substrate, there can be mentioned a method consisting of the steps of: mixing appropriately necessary materials in the resin described above; dispersing the mixture using a paint shaker, sand mill, pearl mill, ball mill, attritor, roll mill, high-speed impeller disperser, jet mill, high-speed impact mill, ultrasonic disperser, or the like, to form a coating material or an ink; providing one layer or multi-layers on one surface of the transparent substrate by means of a printing method such as a letterpress printing method such as a flexographic printing method or the like, an intaglio printing method such as a direct gravure printing method, offset gravure printing method, or the like, a planographic printing method such as an offset printing method or the like, a stencil printing method such as a screen process printing method or the like, or a coating method such as an air doctor coating method, blade coating method, knife coating method, reverse coating method, transfer roll coating method, gravure roll coating method, kiss coating method, cast coating method, spray coating method, slot orifice coating method, calender coating method, electrodeposition coating method, dip coating method, die coating method or the like; thermal-drying the coating or printing layers in the case where a solvent is included; and curing the coating or printing layers by means of radiation (in the case of UV radiation, a photo-polymerization initiator is necessary). In the case where the radiation is an electron beam, an electron beam having an energy of 50 KeV to 1000 KeV emitted from various electron beam accelerators such as a Cockroft-Walton apparatus, Van de Graff apparatus, resonance transformer apparatus, insulating core transformer apparatus, linear type apparatus, dynamitron type apparatus, high-frequency type apparatus, or the like is employed. In the case where the radiation is UV radiation, the UV radiation emitted from the light of an extra-high pressure mercury vapor lamp, high pressure mercury vapor lamp, low pressure mercury vapor lamp, carbon arc lamp, xenon arc lamp, metal halide lamp, or the like can be employed.

In order to improve the coating aptitude or printing aptitude of a coating material of the optical functional layer, a levelling agent such as silicone oil or the like, fats and oils such as polyethylene wax, carnauba wax, higher alcohols, bisamide, higher fatty acids, or the like, a curing agent such as isocyanate or the like, an additive such as ultra-microparticles having a particle size of 0.05 μm or less, such as those of calcium carbonate, silica sol, synthetic mica, or the like, can be employed, as necessary.

C. Adhesive Layer

As an adhesive employed in an adhesive layer in the present invention, an adhesive in which the adhesive power (180 degree peeling force) in accordance with Japanese Industrial Standard Z-0237 is preferably 1500 g/25 mm or less and more preferably 1000 g/25 mm or less, can be employed by appropriate selection. Furthermore, as an adhesive, it is desirable that peeling and foaming do not occur in a compulsive aging test under high temperature and high humidity, and in addition, it is preferable that re-peelability be possible and there be no adhesive remaining after peeling. As an adhesive having such properties, acrylic adhesive, rubber adhesive, polyvinyl ether adhesive, silicone adhesive, etc., can be employed by appropriate selection. Among these, an acrylic-type adhesive is the most suitable.

Alkyl (meth)acrylate and polymeric unsaturated carboxylic acid or unsaturated ethylene monomer including hydroxyl group, or alkyl (meth)acrylate and copolymeric vinyl monomer, are copolymerized in an organic solvent or aqueous medium, and the acrylic adhesive can thereby be obtained. As a polymerization method, a radical polymerization method, a solution polymerization method, a suspension polymerization method, an emulsion polymerization method, etc., can be employed. With respect to the molecular weight of this copolymer, the number average molecular weight by gel permeation chromatography is preferably 10,000 to 1,000,000, more preferably 50,000 to 500,000, and most preferably 100,000 to 400,000. When the number average molecular weight is below 10,000, it is difficult to uniformly form a resin component layer. In contrast, when the number average molecular weight exceeds 1,000,000, elasticity is increased, and therefore problems occur in which it is difficult to adjust the coating amount, or the like.

As an alkyl (meth)acrylate, methyl (meth)acrylate, butyl (meth)acrylate, octyl (meth)acrylate, which have an alkyl group having 1 to 12 carbon atoms, etc., can be employed. Specifically, as a methacrylate component, methyl methacrylate, ethyl methacrylate, n-propyl methacrylate, isopropyl methacrylate, n-hexyl methacrylate, cyclohexyl methacrylate, 2-ethylhexyl methacrylate, n-octyl methacrylate, isooctyl methacrylate, lauryl methacrylate, etc., can be employed. As an acrylate component, methyl acrylate, ethyl acrylate, propyl acrylate, butyl acrylate, n-hexyl acrylate, 2-ethylhexyl acrylate, n-octyl acrylate, lauryl acrylate, etc., can be employed. These can be employed alone or in combination.

In addition, dispersiveness of carbon is improved by using (meth)acrylate monomer having a carboxyl group and/or hydroxyl group as a functional group together with the above alkyl (meth)acrylate. In particular, when acidic carbon is used, the dispersiveness is further improved. As a monomer having such a functional group, (meth)acrylic acid, maleic acid, itaconic acid, and crotonic acid, which have a carboxyl group, 2-hydroxyethyl acrylate, 2-hydroxypropyl acrylate, 2-hydroxy vinyl ether, which have a hydroxyl group, etc., can be employed. These can be employed alone or in combination by mixing with the above (meth)acrylate component.

In these adhesives, crosslinking agents can also be mixed. As a crosslinking agent, isocyanate compound, aluminum chelate, aziridinyl compound, epoxy compound, etc., can be employed. In general, the mixing amount of this crosslinking agent is preferably 0.01 to 10 weight parts to 100 weight parts of the acrylic adhesive. An adhesive as described in the above is dissolved in an organic solvent and this solution is coated on a transparent substrate by a coating machine such as roll coater, reverse coater, comma coater, lip coater, dye coater, etc., and thereby an adhesive layer is provided. In this case, a film, paper, or the like, which is subjected to a peeling treatment, is laminated to the surface without transparent substrate of the adhesive layer, and convenience in handling can thereby be provided.

D. Other Layer

In the present invention, the above transparent substrate, optical functional layer, and adhesive layer are the basic composition, and in addition, a hard coat layer, an anti-glare layer, etc., can be provided by laminating as necessary. It is preferable that the hard coat layer be provided in the case in which a hard coat agent (resin) is not used as a binding agent of the above optical functional layer. The hard coat layer and anti-glare layer are provided between a transparent substrate and an optical functional layer or on the surface of the optical functional layer, in the same manner as the above coating method of the optical functional layer. In the following, these are explained.

\mathring{1} Hard Coat Layer

As a resin for forming a hard coat layer, resins for hard coating can be employed. In the present invention, a “hard coat” refers to one having a pencil hardness of H or more described in the following. As the resin, a resin cured by means of radiation or heat, or a combination thereof, can be employed. As a radiation curable resin, compounds appropriately mixed with monomers, oligomers, or prepolymers having polymeric unsaturated bonds such as for an acryloyl group, methacryloyl group, acryloyloxy group, methacryloyloxy group, or the like, can be employed. As a monomer, acrylic acid derivatives of monofunctional acrylates such as styrene, methyl acrylate, lauryl acrylate, ethoxy diethylene glycol acrylate, methoxy triethyleneglycol acrylate, phenoxy ethylacrylate, tetrahydrofurfuryl acrylate, isobornyl acrylate, 2-hydroxyethyl acrylate, 2-hydroxypropyl acrylate, 2-hydroxy-3-phenoxy acrylate, or the like; and of multifunctional acrylates such as neopentylglycol diacrylate, 1,6-hexanediol diacrylate, trimethylolpropane triacrylate, pentaerythritol triacrylate, pentaerythritol tetraacrylate, dipentaerythritol hexaacrylate, trimethylolpropane acrylic acid benzoate, trimethylolpropane benzoate, or the like; methacrylic acid derivatives of monofunctional methacrylate such as methyl methacrylate, 2-ethylhexyl methacrylate, n-stearyl methacrylate, cyclohexyl methacrylate, tetrahydrofurfuryl methacrylate, phenoxyethyl methacrylate, methoxy polyethylene methacrylate, 2-hydroxyethyl methacrylate, 2-hydroxybutyl methacrylate, etc.; and of multifunctional methacrylates such as 1,6-hexanediol dimethacrylate, trimethylolpropane trimethacrylate, glycerol dimethacrylate, ethylene glycol dimethacrylate, or the like; a urethane acrylate such as glycerin dimethacrylate hexamethylene diisocyanate, pentaerythritol triacrylate hexamethylene diisocyanate, or the like; can be mentioned. As an oligomer or prepolymer, an acrylate such as polyester acrylate, polyurethane acrylate, epoxy acrylate, polyether acrylate, alkyd acrylate, melamine acrylate, silicone acrylate, or the like, an unsaturated polyester, an epoxy-type compound, or the like, can be mentioned. These can be employed alone or in combination. In the case in which flexibility of the curing film is required, the amount of monomer employed is reduced. Furthermore, in order to reduce cross-linking density, it is preferable that an acrylic monomer having a mono-functional or bi-functional acrylate be employed. Whereas in the case in which superior durability such as thermal resistance, wear resistance, solvent resistance, or the like, is required in the curing film, it is preferable that the amount of monomer be increased or that an acrylic monomer having a tri-functional or greater acrylate be employed.

In order to cure the radiation curable resin as described above, for example, it is necessary that radiation such as UV, electron beams, X-rays, or the like, be irradiated on the resin, and a polymerization initiator can be appropriately added to the resin, as necessary. In the case of curing by means of irradiating with UV, a photopolymerization initiator must be added. As a photopolymerization initiator, an acetophenone such as diethoxy acetophenone, 2-hydroxy-2-methyl-1-phenylpropan-1-one, benzyl dimethyl ketal, 1-hydroxycyclohexyl-phenylketone, 2-methyl-2-monophorino (4-thiomethylphenyl)propan-1-one, or the like; a benzoin ether such as benzoin methylether, benzoin ethylether, benzoin isopropylether, benzoin isobutylether, or the like; a benzophenone such as benzophenone, o-benzoyl methyl benzoate, 4-phenyl benzophenone, 4-benzoyl-4′-methyl-diphenylsulfide, 4-benzoyl-N,N-dimethyl-N-[2-(1-oxo-2-propenyloxy)ethyl]benzene methanaminuim bromide, (4-benzoylbenzyl)trimethyl ammonium chloride, or the like; a thioxanthone such as 2,4-diethyl thioxanthone, 1-chloro-4-dichloro thioxanthone, or the like; 2,4,6-trimethylbenzoyl diphenylbenzoyl oxide, or the like; can be mentioned. These can be employed alone or in combination. In addition, as an accelerator (sensitizer), an amine-type compound such as N,N-dimethyl paratoluidine, 4,4′-diethylamino benzophenone, or the like, can be employed in combination. The content of the photopolymerization initiator is preferably in an amount of 0.1 to 10.0% by weight to the radiation curable resin. If the content is not in this range, UV-curing is insufficient.

In the present invention, an epoxy-type compound cured by UV-rays can be employed as a radiation curable resin and a cationic polymerization initiator can be employed as a photopolymerization initiator. In particular, in the case in which a TAC film is employed as a transparent substrate, the epoxy-type compound and the cationic polymerization initiator are preferably employed since superior adhesion to the TAC film can be exhibited.

As an example of epoxy-type compounds, a glycidyl ether such as tetramethylene glycol diglycidyl ether, propylene glycol diglycidyl ether, neopentyl glycol diglycidyl ether, bisphenol A diglycidyl ether, or the like, an epoxy ester such as 2-hydroxy-3-phenoxypropyl acrylate, an adduct of bisphenol A-diepoxy-acrylic acid, or the like, as well as a monomer and an oligomer such as an alicyclic epoxy represented by the following formulas, can be mentioned.

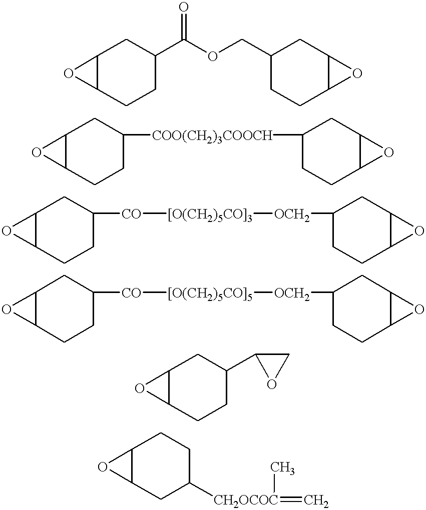

As a photo-cationic polymerization initiator, compounds represented by the following formulas can be employed. In the following formulas, R₁ and R₂ represent alkyl groups having one to six carbon atoms. Benzene rings in the following formulas may have any substituent. As a substituent, an alkyl group having one to six carbon atoms, a halogen, etc., can be mentioned. These can be employed alone or in combination.

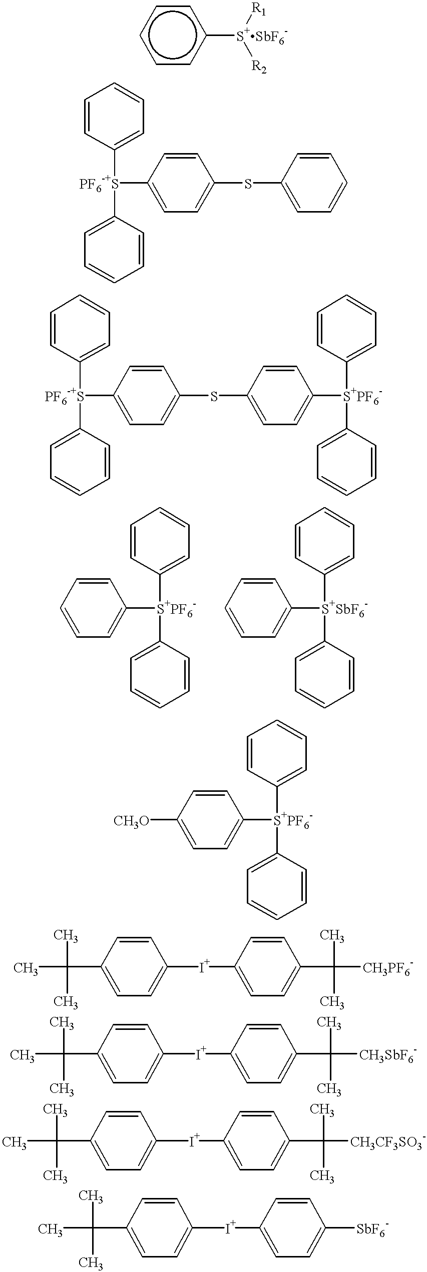

The volumetric shrinkage ratio associated with curing of the hard coat layer employing the above radiation curable resin (calculated by the following method) is preferably 20% or less. When the volumetric shrinkage ratio exceeds 20%, in the case of a film-shaped transparent substrate, the film will curl severely, and in the case of a rigid substrate such as a glass or the like, the adhesion between the substrate and the hard coat layer will be reduced.

Volumetric shrinkage ratio: D=(S-S′)/S×100

wherein S: specific gravity before curing

S′: specific gravity after curing

(Specific gravity is measured by the B method picnometer method of Japanese Industrial Standard K-7112.)

In the hard coat layer according to the present invention, a stabilizer (a thermal polymerization inhibitor) for the radiation curable resin such as hydroquinone, p-benzoquinone, t-butylhydroquinone, etc., may be added. It is preferred that the stabilizer be employed in a range of 0.1 to 5.0% by weight to the radiation curable resin.

As a thermosetting resin which can be used in the hard coat layer, phenol resin, furan resin, xylene-formaldehyde resin, ketone-formaldehyde resin, urea resin, melamine resin, aniline resin, alkyd resin, unsaturated polyester resin, epoxy resin, etc., can be employed. These may be employed alone or in combination. In the case in which a transparent substrate consists of plastics, the heat curing temperature cannot be set at a high temperature. In particular, in the case in which PET or TAC is employed, a thermosetting resin which can be cured at 100° C. or less is desirably employed.

It is preferable that the curable resin employed in the hard coat layer have a higher transparency. The light transmittance (Japanese Industrial Standard C-6714) is preferably 80% or more and more preferably 90% or more, in the same way as the transparent substrate. The anti-reflection property of the adhesive film is affected by the refractive index of the curable resin. The refractive index of the above curable resin is preferably in a range of 1.45 to 1.70, and more preferably in a range of 1.5 to 1.65. With a refractive index outside of the range described above, anti-reflection effects are degraded.

The thickness of the hard coat layer is preferably in a range of 0.5 to 10 μm, and more preferably in a range of 1 to 5 μm. In the case where the thickness of the hard coat layer is less than 0.5 μm, wear resistance of the hard coat layer is degraded, or in the case of a UV-curable resin being employed in the hard coat layer, the resin fails to cure due to oxidation inhibition. In contrast, in the case where the thickness of the hard coat layer is more than 10 μm, curling occurs due to curing-shrinkage of the resin, microcracking occurs in the hard coat layer, or the adhesion between the transparent substrate and the hard coat layer is decreased.

\mathring{2} Anti-glare Layer

As an aspect of the present invention, an anti-glare layer may be further provided in addition to the basic composition. The anti-glare layer is formed by containing a filler in a resin generally used as a binding agent, preferably the above resin for forming a hard coat layer. The light is scattered or diffused by roughening the surface thereof, and thereby the anti-glare effects can be obtained. As the filler, there can be mentioned an inorganic white pigment such as silica, calcium carbonate, aluminum hydroxide, magnesium hydroxide, clay, talc, titanium dioxide, or the like, or an organic transparent or white pigment such as an acrylic resin, polystyrene resin, polyethylene resin, epoxy resin, silicone resin, or the like. In particular, an organic filler which is spheroidal and does not exhibit oil absorbing properties is preferable. By means of employing spheroidal fillers, the projecting parts projecting from the surface of the anti-glare layer are moderated, and contaminants such as oil do not adhere well, and in addition, it is easy to wipe off adhering contaminants.

Such a filler preferably has a particle size D (Japanese Industrial Standard B9921) wherein the particles having a particle size D in a range of 0.5 μm≦D≦6.0 μm are present in an amount of 60% or more by weight, particles having a particle size D in a range of 6.0 μm<D≦10.0 μm are present in an amount of less than 20% by weight, particles having a particle size D in a range of 10.0 μm<D≦15.0 μm are present in an amount of 5% or less by weight, and particles having a particle size D of more than 15.0 μm are present in an amount of 1.0% or less by weight. In addition, it is preferred that particles having a particle size D of more than 15 μm are not present (0%), insofar as is possible. In particular, it is preferred that the particles having a particle size D in a range of 0.5 μm≦D≦6.0 μm are present in an amount of 80% or more by weight, particles having a particle size D in a range of 6.0 μm<D≦10.0 μm are present in an amount of less than 10% by weight, and particles having a particle size D in a range of 10.0 μm<D≦15.0 μm are not present at all.

In the case in which a filler has a particle size D wherein the particles having a particle size D in a range of 0.5 μm≦D≦6.0 μm, particles having a particle size D in a range of 6.0 μm<D≦10.0 μm, and particles having a particle size D in a range of 10.0 μm<D≦15.0 μm are present in an amount of less than 60% by weight, less than 20% by weight, and less than 5% by weight, respectively, anti-reflection effects of displays are degraded. In contrast, in the case in which a filler has a particle size D wherein the particles having a particle size D in a range of 6.0 μm<D≦10.0 μm are present in an amount of 20% or more by weight, or the particles having a particle size D in a range of 10.0 μm<D≦15.0 μm are present in an amount of 5% or more by weight, the image on the display glitters.

The filler is preferably present in an amount of 0.5 to 30% in the total solid ratio of the anti-glare layer. In particular, it is more preferably present in a range of 1 to 15%. With 0.5% or less of the filler, sufficient anti-reflection effects cannot be obtained. On the other hand, with 30% or more of the filler, not only are the transparency and the contrast of the image degraded, but also durability such as wear resistance, environmental resistance, and the like is impaired. In addition, the refractive index of the filler (B method according to Japanese Industrial Standard K-7142) is preferably equivalent to that of the curable resin. In the case where the refractive index of the filler is different as from that of the curable resin, light is scattered at the interface of the resin and the filler, and therefore the transparency is impaired. As an example of fillers having a refractive index equivalent to that of the curable resin, there can be mentioned organic fillers, and in particular crosslinked acryl beads.

As the crosslinked acryl beads, those consisting of polymers and copolymers obtained by means of polymerization such as suspension polymerization using an acrylic monomer such as acrylic acid and an ester thereof, methacrylic acid and an ester thereof, acrylic amide, acrylonitrile, or the like, a polymerization initiator such as persulfuric acid, or the like, and a crosslinking agent such as ethylene glycol dimethacrylate, or the like, is preferably employed. In particular, as an acrylic monomer, a monomer using methyl methacrylate is preferred. The crosslinked acrylic beads thus obtained are spheroidal and do not exhibit oil absorbing characteristics. For this reason, in the case where the beads are employed in the anti-glare layer, excellent stain resistance can be exhibited. In addition, the crosslinked acrylic beads may be surface-treated by fats and oils, a silane-coupling agent, an organic or inorganic material such as a metal oxide, or the like in order to improve dispensability of the coating material.

In the adhesive film according to the present invention having the laminated composition described in the above, the HAZE value according to Japanese Industrial Standard K-7105 is preferably in a range of 3 to 30, and more preferably in a range of 5 to 15. With a HAZE value of less than 3, the light scattering effects are small, and therefore sufficient anti-reflection effects cannot be obtained. On the other hand, with a HAZE value of more than 30, the image contrast is degraded and visibility is degraded, and for these reasons, it is not preferred since an inferior display will result. The HAZE value is a clouding value, and it is calculated according to the following expression by measuring a luminous diffuse transmittance (Td %) and a total light transmittance (Tt %) using an integrating sphere type light transmittance measuring apparatus.

HAZE value=Td/Tt×100

### BRIEF DESCRIPTION OF THE DRAWINGS

FIG. 1 is a schematic cross-sectional drawing showing a structure of an adhesive film for a display according to an embodiment of the present invention;

FIG. 2 is a schematic cross-sectional drawing showing a structure of an adhesive film for a display according to another embodiment of the present invention;

FIG. 3 is a schematic cross-sectional drawing showing a structure of an adhesive film for a display according to another embodiment of the present invention; and

FIG. 4 is a schematic cross-sectional drawing showing a structure of an adhesive film for a display according to another embodiment of the present invention.

### DETAILED DESCRIPTION OF THE PREFERRED EMBODIMENTS

As In the following, an adhesive film for a display according to the present invention will be explained in detail with reference to the accompanying drawings.

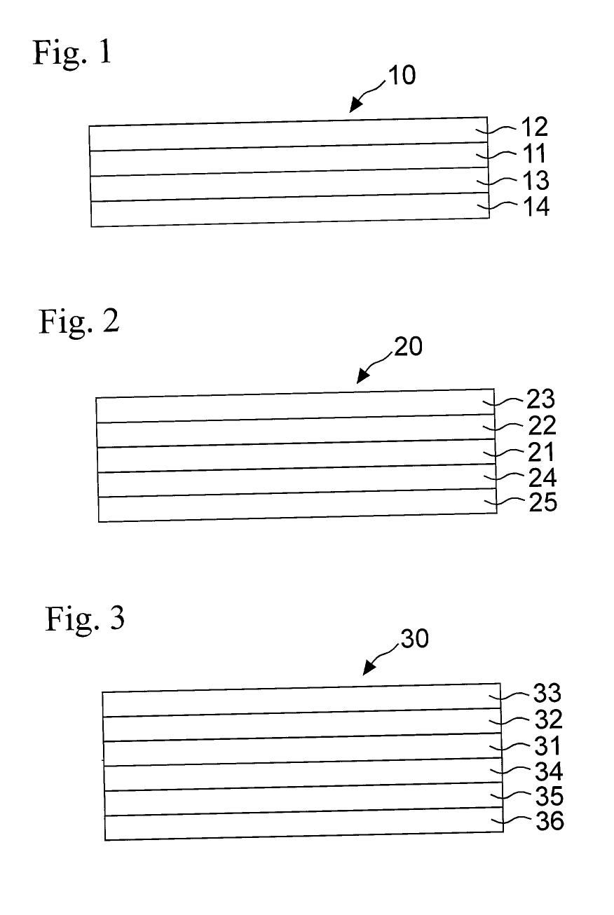

FIG. 1 is a schematic cross-sectional drawing showing a basic composition of an adhesive film according to the present invention. The adhesive film 10 comprises a transparent substrate 11, an optical functional layer 12 (colored) formed on one surface of the transparent substrate 11, an adhesive layer 13 (colored) formed on the other surface of the transparent substrate 11, and a separation film 14 further provided on the surface of the adhesive layer 13. In this case, the optical functional layer 12 consists of at least one layer of an anti-reflection layer, an anti-static layer, and an infrared ray blocking layer, or it is formed so as to have two or more functions thereof. The infrared ray blocking layer may be formed between the transparent substrate 11 and the adhesive layer 13.

FIG. 2 is a schematic cross-sectional drawing showing an example of a composition of an adhesive film according to the present invention. The adhesive film 20 comprises a transparent substrate 21, a hard coat layer 22 and an anti-reflection hard coat layer 23 (colored) as an optical functional layer formed on one surface of the transparent substrate 21 in this order, an adhesive layer 24 (colored) formed on the other surface of the transparent substrate 21, and a separation film 25 further provided on the surface of the adhesive layer 24.

FIG. 3 is a schematic cross-sectional drawing showing an example of a composition of an adhesive film according to the present invention. The adhesive film 30 comprises a transparent substrate 31, an anti-reflection hard coat layer 32 (colored) as a first optical functional layer and an anti-static layer 33 (colored) as a second optical functional layer formed on one surface of the transparent substrate 31 in this order, an infrared ray blocking layer 34 (colored) as a third optical functional layer and an adhesive layer 35 (colored) formed on the other surface of the transparent substrate 31 in this order, and a separation film 36 further provided on the surface of the adhesive layer 35.

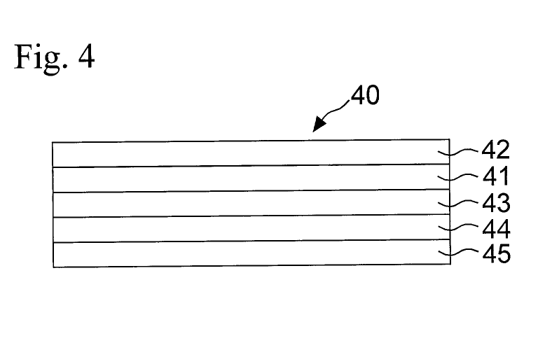

FIG. 4 is a schematic cross-sectional drawing showing an example of a composition of an adhesive film according to the present invention. The adhesive film 40 comprises a transparent substrate 41, an anti-reflection and anti-static hard coat layer 42 (colored) as a first optical functional layer formed on one surface of the transparent substrate 41, an infrared ray blocking layer 43 (colored) as a second optical functional layer and an adhesive layer 44 (colored) formed on the other surface of the transparent substrate 41 in this order, and a separation film 45 further provided on the surface of the adhesive layer 44.

As described above, the optical functional layer 12 and the adhesive layer 13 in FIG. 1, the anti-reflection hard coat layer 23 and the adhesive layer 24 in FIG. 2, the anti-reflection hard coat layer 32, the anti-static layer 33, the infrared ray blocking layer 34 and the adhesive layer 35 in FIG. 3, the anti-reflection and anti-static hard coat layer 42, the infrared ray blocking layer 43 and the adhesive layer 44 in FIG. 4, are colored. These colors were predetermined so that the overall color of the adhesive film as a final product was made to be achromatic. Consequently, these adhesive films for display of the present invention can exhibit superior image contrast and color reproduction. FIGS. 2 to 4 merely show examples of an adhesive film for a display of the present invention, and the present invention is not limited to these laminated compositions.

### EXAMPLES

The present invention will be explained in more detail by the Examples. In the following, “parts” refer to “parts by weight”.

Polymerization of Acrylic Polymer a

94 parts of n-butyl acrylate, 6 parts of acrylic acid, 0.3 parts of benzoyl peroxide, 40 parts of ethyl acetate, and 60 parts of toluene were added in a flask having a thermometer, a stirrer, a reflux condenser, and a nitrogen feeding tube. The flask was filled with nitrogen by feeding nitrogen thereinto through the nitrogen feeding tube, and was heated to 65° C., and the polymerization reaction was allowed to proceed for 10 hours. An acrylic polymer solution having a weight average molecular weight of about 1,200,000 (a number average molecular weight of about 300,000) and a Tg of about −49° C. was thereby obtained. Subsequently, ethyl acetate was added in this acrylic polymer solution, and therefore, an acrylic polymer a (solid concentration of 20% by weight) was prepared.

### Example 1

A dispersion liquid obtained by dispersing a mixture of conductive material, low refractive material, and the like at the composition ratio described below, using a pearl mill for 30 minutes, and a base coating material, described below, were stirred for 15 minutes with a disper. The mixed coating material was coated on one surface of polyethylene terephthalate (trade name: Merinex 535, produced by Teijin Du Pont Co., Ltd.) which is a transparent substrate having a film thickness of 188 μm and a light transmittance of 91%, by means of a reverse coating method and was subsequently dried for 30 seconds at 100° C. Subsequently, the film was irradiated with UV radiation to cure the coating film, under the conditions of output powder: 120 W/cm, radiation distance (distance between the center of the lamp and the coating face): 10 cm, treatment speed (speed with respect to the mercury lamp at the coating substrate): 10 m/min, using one converging type high-pressure mercury lamp. Therefore, an anti-reflection and anti-static hard coat layer having a thickness of 7.1 μm was formed.

<Composition of the Dispersion Liquid>

Conductive Material

Tin oxide (trade name: SN 100, produced by Ishihara Sangyo Kaisha, Ltd.; particle size 100 nm), 200 parts

Low refractive index material

Silica sol (trade name: OSCAL special, produced by Catalysts & Chemicals Industries Co., Ltd.; solid concentration in Methylethylketone (MEK) diluent 20%, particle size 7 nm), 65 parts

Titanate-type dispersing agent (trade name: T-50, produced by Nippon Soda Co., Ltd.), 7 parts

MEK, 540 parts

Isobutanol, 410 parts

Diacetone alcohol, 130 parts

<Composition of the Base Coating Material>

UV curable resin (trade name: Unidic 17-806, produced by Dainippon ink and Chemicals, Inc.; solid concentration 80%), 250 parts

Photopolymerization initiator (trade name: Irgacure 907, Chiba Specialty Chemicals K. K.), 10 parts,

MEK, 145 parts

Next, 0.1 parts of N,N,N′,N′-tetraglycidyl-m-xylene diamine was added to 500 parts of the above acrylic polymer solution a, and an adhesive coating solution a′ was obtained. In addition, 6 parts of color pigments (carbon black/dioxane violet/monochloro cyanine blue=75/12.5/12.5) were added to 500 parts of another acrylic polymer solution a and were stirred, and a color pigment solution A in which the color pigments were sufficiently dispersed therein was produced.

0.2 parts of the color pigment solution A was added to 100 parts of the adhesive coating solution a′ (adhesive solid concentration 20% by weight), and was stirred so as to be uniform. Subsequently, the mixture was coated on a PET film which was subjected to peeling treatment having a thickness of 38 μm so that a thickness of a color adhesive layer after drying was 20 μm, and was dried. Next, the surface of the coloring adhesive layer was adhered to a surface, in which the hard coat layer was not provided, of the above transparent substrate, and an adhesive film for a display of the present invention was thereby obtained.

### Example 2

A base coating material at the composition ratio described below was stirred for 15 minutes with a disper. The mixed coating material was coated on one surface of a transparent substrate, dried, and cured, in the same manner as in Example 1. Therefore, a hard coat layer having an infrared ray blocking function was provided. Subsequently, a coloring adhesive layer was formed in the same manner as in Example 1, and an adhesive film for a display of the present invention was thereby obtained.

<Composition of the Base Coating Material>

Infrared ray blocking agent

ITO powder (primary particle size: about 50 nm; component mole ratio: In/Sn/O₂=100/5/0.9), 52 parts

UV curable resin (trade name: Unidic 17-806, produced by Dainippon ink and Chemicals, Inc.; solid concentration 80%), 24 parts

Photopolymerization initiator (trade name: Irgacure 907, Chiba Specialty Chemicals K. K.), 1 part,

Methylisobutylketone, 24 parts

### Comparative Example

An adhesive film of the Comparative Example was produced in the same manner as in Example 1, except that a non-coloring adhesive layer was provided without addition of color pigment solution A in Example 1.

With regard to the adhesive films of Examples 1 and 2 and the Comparative Example as obtained above, measurements of the value a and the value b and evaluations of image contrast were carried out by the following methods. The results are shown in Table 1.

1. Lab Hue

A PET film subjected to peeling treatment was peeled from each adhesive film, and the adhesive film was adhered to a glass plate (trade name: micro slide glass, produced by Matsunami Glass Corporation), and a value a and a value b thereof were measured using a spectrophotometer (trade name: visible UV spectroscopy photometer UVDEC-670, produced by Japan Spectroscopy Co., Ltd.).

2. Image Contrast

A PET film subjected to peeling treatment was peeled from each adhesive film, and the adhesive film was adhered to the left half of a screen of a color graphics electronic display for a personal computer (trade name: D1726T-HS, produced by DELL Co., Ltd.), and black and white contrasts (film adhered surface and film non-adhered surface) of the right and left of the screen was evaluated by visual observation. In this evaluation, the following criteria were used: cases where the contrast was improved: ◯; cases where the contrast was not changed: Δ; cases where the contrast was deteriorated: X. In this case, brightness of display was set at the highest level.

TABLE 1

| | Value a | Value b | Image Contrast |
|---|---|---|---|
| Example 1 | −1.50 | −0.60 | ◯ |
| Example 2 | −1.34 | −0.57 | ◯ |
| Comparative | −3.15 | −6.77 | Δ |
| Example | | | |

As is apparent from the results shown in Table 1, in adhesive films of Examples 1 and 2, both value a and value b were nearly zero and the overall color thereof was achromatic. In contrast, in an adhesive film of the Comparative Example, both value a and value b were not nearly zero and the color reproduction by the display was affected. In addition, with respect to the evaluation of the black and white contrast of the display surface to which the adhesive film was adhered, in the Comparative Example, the contrast in the film adhered surface was similar to that in the film non-adhered surface. In contrast, in Examples 1 and 2, the film adhered surfaces distinguished between black and white more clearly than the film non-adhered surfaces, and the black and white contrasts could be improved.

As explained above, according to the present invention, in an adhesive film for a display exhibiting anti-reflection property, anti-static property, and infrared ray blocking property, at least two layers of the laminated composition are colored and these colors are made to be achromatic by mixing, and superior image contrast and color reproduction can thereby be exhibited.

What is claimed is:

1. An adhesive film for a display, comprising at least three layers of a transparent substrate, an optical functional layer, and an adhesive layer, at least two of said layers being colored, and said colors are achromatic by mixing.

2. An adhesive film for a display, in accordance with claim 1, wherein said optical functional layer is provided on one surface of said transparent substrate, said adhesive layer is provided on the other surface of said transparent substrate, and said optical functional layer has at least one of an anti-reflection function, an anti-static function, and an infrared ray blocking function.

3. An adhesive film for a display, in accordance with claim 1, wherein said optical functional layer and said adhesive layer are provided on one surface of said transparent substrate in this order, and said optical functional layer has an infrared ray blocking function.

4. An adhesive film for a display, in accordance with claim 1, wherein said optical functional layer contains a hard coat material.

5. An adhesive film for a display, in accordance with claim 2, wherein said optical functional layer contains a hard coat material.

6. An adhesive film for a display, in accordance with claim 3, wherein a hard coat layer is provided on the other surface of said transparent substrate.
